(19) United States
(12) Patent Application Publication
(10) Pub. No.: US 2017/0370233 A1
(43) Pub. Date: Dec. 28, 2017

(54) ENHANCED DURABILITY NICKEL ABRASION STRIP

(71) Applicant: Sikorsky Aircraft Corporation, Stratford, CT (US)

(72) Inventors: Jeffrey Kinlan, Shelton, CT (US); Leon M. Meyer, Harwinton, CT (US)

(21) Appl. No.: 15/534,375

(22) PCT Filed: Jan. 15, 2016
(86) PCT No.: PCT/US2016/013526

§ 371 Date: Jun. 8, 2017

Related U.S. Application Data
(60) Provisional application No. 62/105,488, filed on Jan. 20, 2015.

(51) Int. Cl. F01D 5/28; F01D 5/14; B64C 27/473

(52) U.S. Cl. CPC F01D 5/288; B64C 27/473; F01D 5/141; B64C 2027/4736; F05D 2300/171; F05D 2300/175; F05D 2240/303

(57) ABSTRACT

An erosion strip to protect a leading edge surface is provided including an outer layer comprising a wear-resistant material. An elastomer is affixed to an interior surface of the outer layer. An adhesive layer is shaped to adhere the leading edge surface to the elastomer such that the elastomer and adhesive layers are between the outer layer and the leading edge surface. The elastomer is configured to at least partially isolate strain at the outer layer from strain at the adhesive layer and the leading edge surface.

### BACKGROUND OF THE INVENTION

Exemplary embodiments of the invention relate to a rotary-wing aircraft and, more particularly, to a main rotor blade of a rotary-wing aircraft.

Rotary wing aircrafts include a plurality of main rotor blades coupled to a central hub. The rotor blades include aerodynamic surfaces that, when rotated, create lift. The configuration of the main rotor blades, particularly the tip section thereof, is selected to enhance rotor blade performance, for example to increase the hover and lift capabilities of the rotary-wing aircraft. Rotor blades are subjected to high stresses and strains resulting from aerodynamic forces developed during operation.

The leading edges of helicopter rotor blades are subject to wear, such as fatigue wear for example, due to vibratory loads. In particular there is a recurring problem of erosion of the metal leading edge abrasion strips of the main rotor blades. When such erosion occurs, the affected rotor blades must be removed from the helicopter and sent for repair, resulting in several weeks of downtime for the aircraft.

### BRIEF DESCRIPTION OF THE INVENTION

According to one embodiment of the invention, an erosion strip to protect a leading edge surface is provided including an outer layer comprising a wear-resistant material. An elastomer is affixed to an interior surface of the outer layer. An adhesive layer is shaped to adhere the leading edge surface to the elastomer such that the elastomer and adhesive layers are between the outer layer and the leading edge surface. The elastomer is configured to at least partially isolate strain at the outer layer from strain between the adhesive layer and the leading edge surface.

In addition to one or more of the features described above, or as an alternative, in further embodiments the outer layer is formed from a nickel material.

In addition to one or more of the features described above, or as an alternative, in further embodiments the elastomer is bonded to the interior surface of the outer layer with an epoxy.

In addition to one or more of the features described above, or as an alternative, in further embodiments the elastomer is vulcanized to the interior surface of the outer layer.

In addition to one or more of the features described above, or as an alternative, in further embodiments the elastomer extends over all of the interior surface of the outer layer.

In addition to one or more of the features described above, or as an alternative, in further embodiments the outer layer is formed from a ceramic material.

According to another embodiment of the invention, a main rotor blade assembly is provided including a spar having a leading edge assembly. The leading edge assembly includes a main sheath laminate and a first erosion strip. The first erosion strip includes a wear-resistant outer layer, a layer of elastomer attached to and extending over at least a portion of an interior surface of the outer layer, and an adhesive which adheres the elastomer to the main sheath laminate. The elastomer is configured to at least partially isolate the strain at the outer layer from strain generated between the adhesive and the main sheath laminate.

In addition to one or more of the features described above, or as an alternative, in further embodiments the elastomer is vulcanized to the interior surface of the outer layer.

In addition to one or more of the features described above, or as an alternative, in further embodiments the elastomer is bonded to the interior surface of the outer layer with an epoxy.

In addition to one or more of the features described above, or as an alternative, in further embodiments an adhesive is arranged over an exposed surface of the elastomer. The adhesive is configured to couple the erosion strip to an adjacent component of the leading edge assembly.

In addition to one or more of the features described above, or as an alternative, in further embodiments the adhesive bonds the first erosion strip directly to a portion of the main sheath laminate.

In addition to one or more of the features described above, or as an alternative, in further embodiments the leading edge assembly includes a second erosion strip mounted upon the main sheath laminate. The second erosion strip is formed from a wear-resistant material, wherein the adhesive is configured to bond the first erosion strip to the second erosion strip.

A method of installing an erosion strip of a main rotor blade is provided including preparing a surface of an adjacent component configured to receive the erosion strip. The erosion strip includes an outer layer of a wear resistant material an elastomer affixed to a portion of the outer layer. The elastomer is configured to at least partially isolate the outer layer from strain generated in the erosion strip. An adhesive configured to couple the erosion strip to the adjacent component is prepared and the erosion strip is affixed to the adjacent component.

### BRIEF DESCRIPTION OF THE DRAWINGS

The subject matter, which is regarded as the invention, is particularly pointed out and distinctly claimed in the claims at the conclusion of the specification. The foregoing and other features, and advantages of the invention are apparent from the following detailed description taken in conjunction with the accompanying drawings in which:

FIG. 1 is a perspective view of an exemplary rotary wing aircraft;

FIG. 2A is a perspective view of a main rotor blade according to an embodiment of the invention;

FIG. 2B is an expanded perspective view of a tip section of the rotor blade of FIG. 2A;

FIG. 2C is an expanded rear oblique perspective view of a tip section of the rotor blade of FIG. 2A;

FIG. 2D is an expanded front oblique perspective view of a tip section of the rotor blade of FIG. 2A;

FIG. 2E is an expanded top view of a top section of the rotor blade of FIG. 2A;

FIG. 2F is an expanded front view of a tip section of the rotor blade of FIG. 2A;

FIG. 3A is a perspective, exploded view of a main rotor blade according to an embodiment of the invention;

FIG. 3B is a top view of a main rotor blade according to an embodiment of the invention;

FIG. 4 is a perspective view of an erosion strip according to an embodiment of the invention; and

FIG. 5 is a flow chart of a method of attaching an the erosion strip to a main rotor blade assembly according to an embodiment of the invention.

The detailed description explains embodiments of the invention, together with advantages and features, by way of example with reference to the drawings.

### DETAILED DESCRIPTION OF THE INVENTION

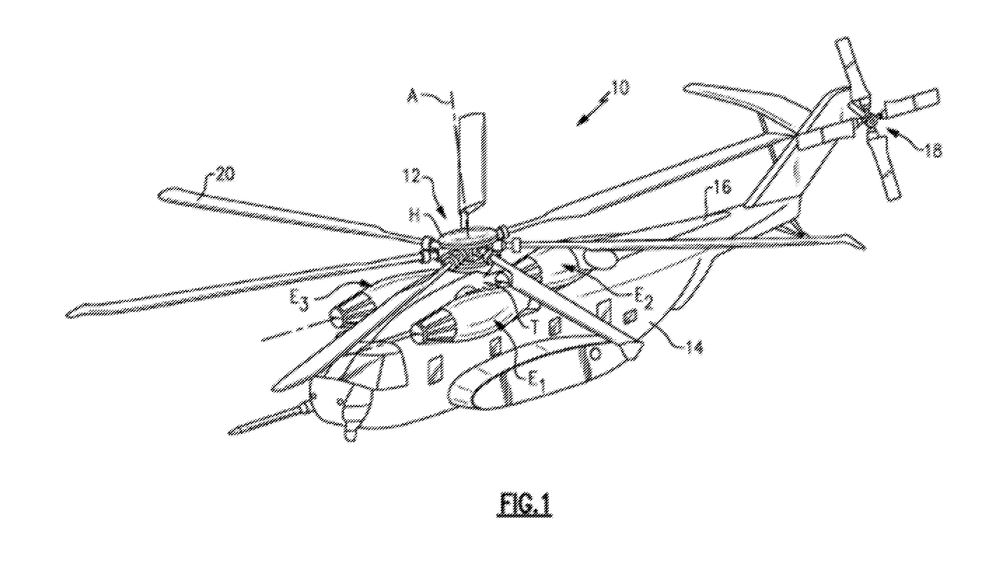

FIG. 1 schematically illustrates a rotary-wing aircraft 10 having a main rotor system 12. The aircraft 10 includes an airframe 14 having an extending tail 16 which mounts a tail rotor system 18, such as an anti-torque system for example. The main rotor assembly 12 is driven about an axis of rotation A through a main gearbox (illustrated schematically at T) by one or more engines E. The main rotor system 12 includes a plurality of rotor blade assemblies 20 mounted to a rotor hub assembly H. Although a particular helicopter configuration is illustrated and described in the disclosed non-limiting embodiment, other configurations and/or machines, such as high speed compound rotary-wing aircrafts with supplemental translational thrust systems, dual contra-rotating, coaxial rotor system aircraft, turbo-props, tilt-rotors, and tilt-wing aircrafts are also within the scope of the invention.

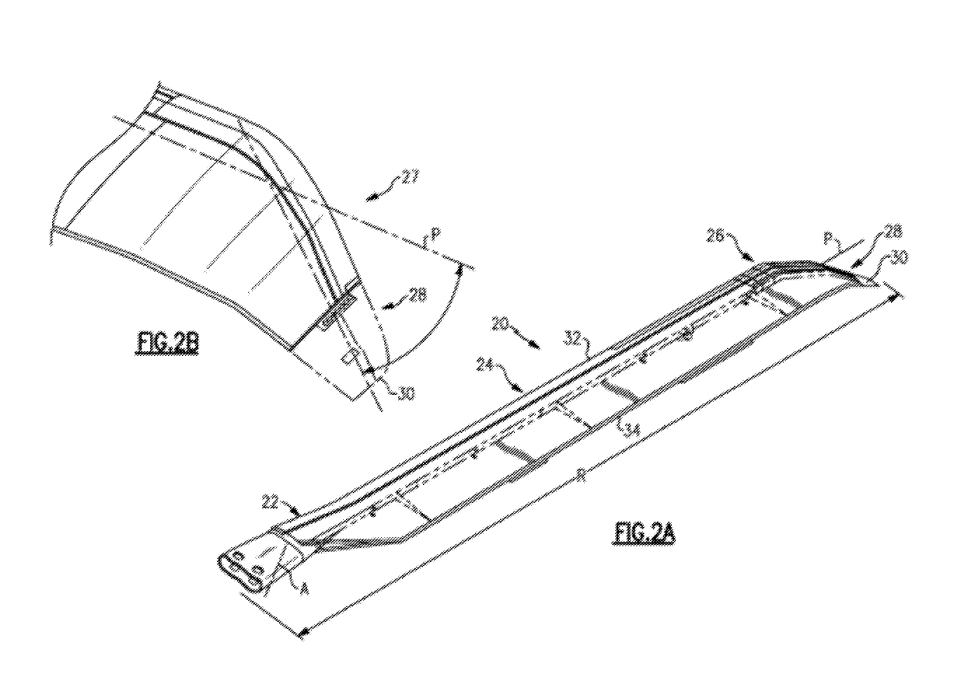

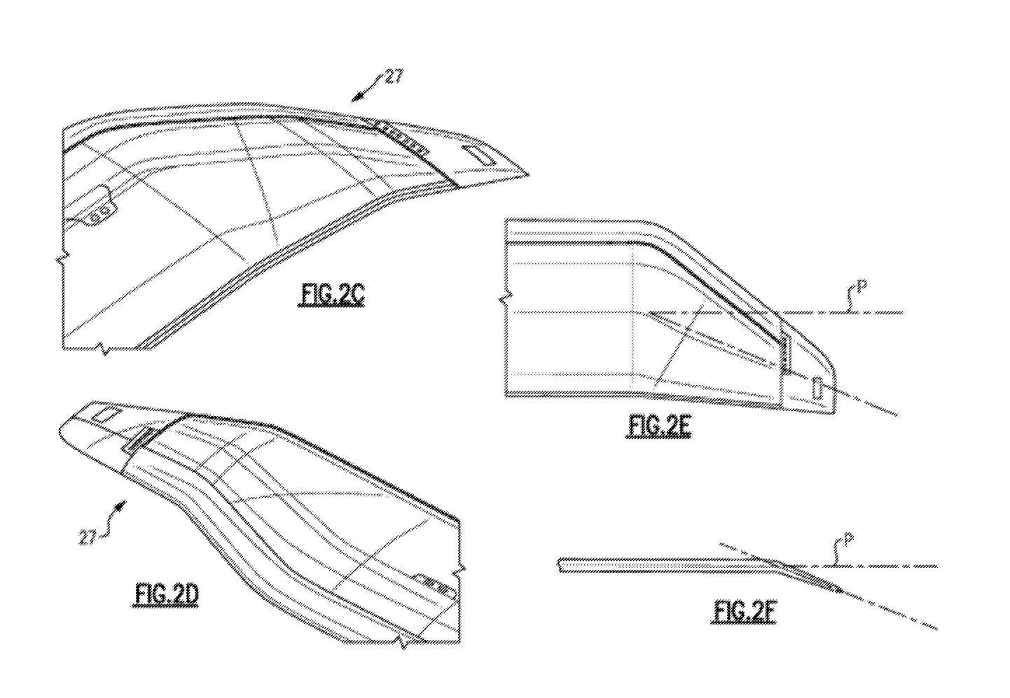

Referring to FIG. 2A, each rotor blade assembly 20 of the rotor assembly 12 generally includes a root section 22, an intermediate section 24, a tip section 26, and a tip cap 28. Each rotor blade section 22, 24, 26, 28 may define particular airfoil geometries to tailor the rotor blade aerodynamics to the velocity increase along the rotor blade span. As, illustrated, the rotor blade tip section 26 may include an anhedral form 27 (FIGS. 2B-2F); however, any angled or non-angles forms such as cathedral, gull, bent, and other non-straight forms are within the scope of the present invention. The anhedral form 27 as defined herein may include a rotor blade tip section 26 which extends at least partially out of a plane defined by the intermediate section 24

The rotor blade sections 22-28 define a span R of the main rotor blade assembly 20 between the axis of rotation A and a distal end 30 of the tip cap 28 such that any radial station may be expressed as a percentage in terms of a blade radius x/R. The rotor blade assembly 20 defines a longitudinal feathering axis P between a leading edge 32 and a trailing edge 34. The distance between the leading edge 32 and the trailing edge 34 defines a main element chord length Cm.

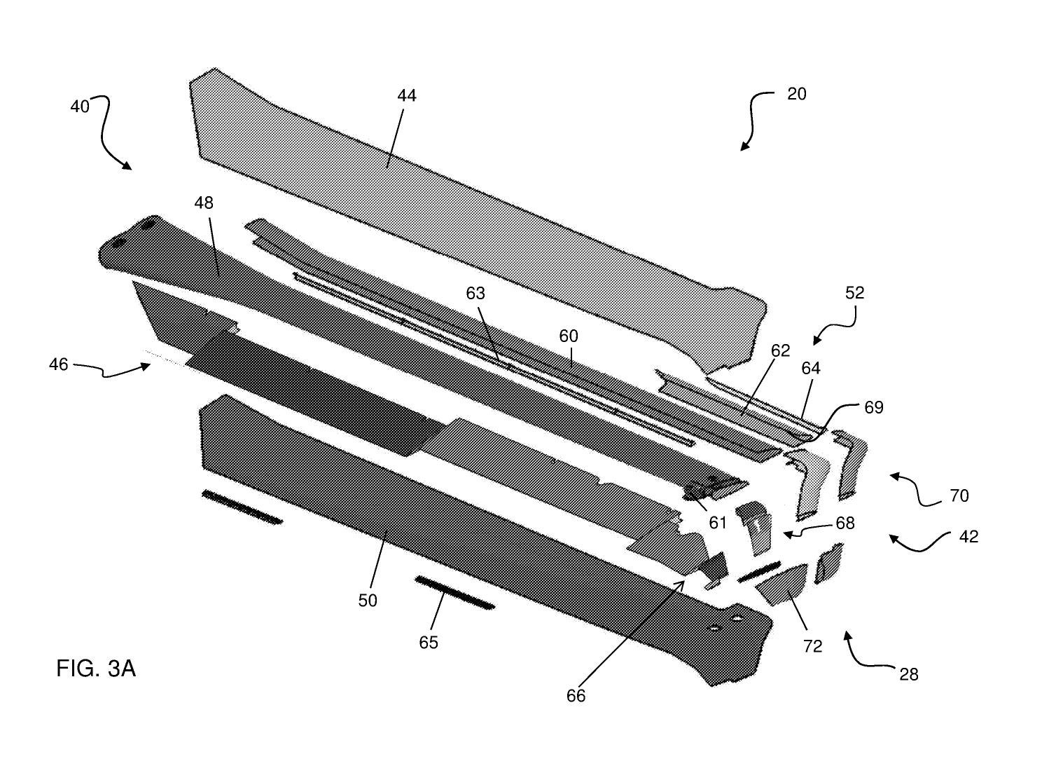

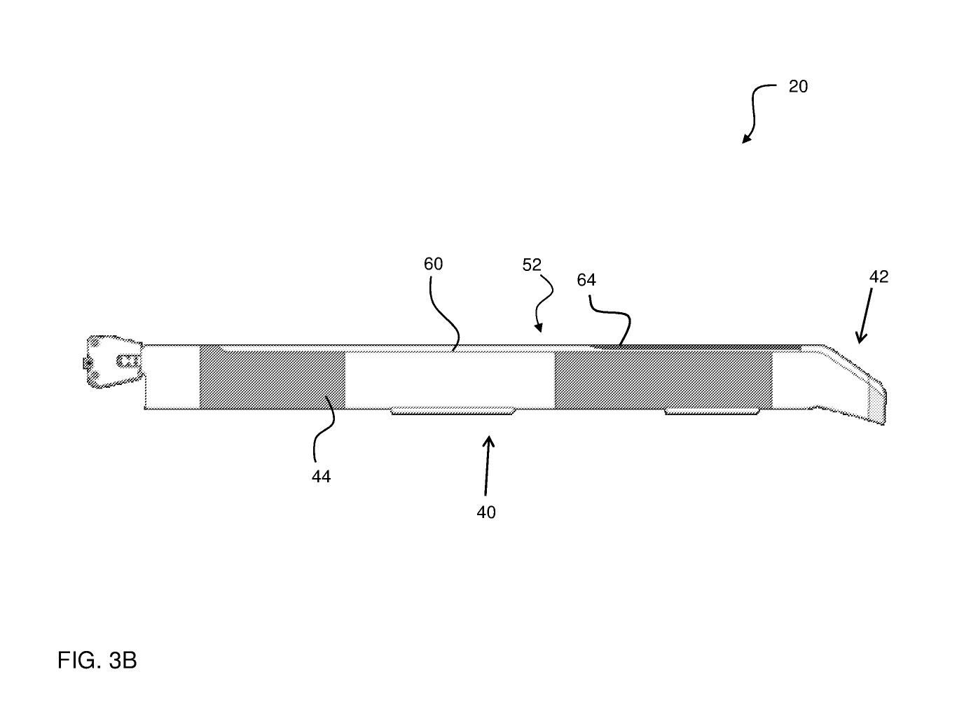

Referring now to FIG. 3A, the rotor blade assembly 20 generally includes a main blade assembly 40 and a tip assembly 42. The main blade assembly 40 includes an upper skin 44, a main core 46, a spar 48, a lower skin 50, and a leading edge assembly 52. The main spar 48, main core 46, and skins 44, 50 are generally referred to as a pocket assembly, the forward portion of which is closed out by the leading edge assembly 52. The spar 48 has a generally constant thickness over most of its length. In one embodiment, the root end of the spar 48 has a substantially increased size, thickness, and/or strength to allow for the attachment of the blade 20 to a rotor hub, such as rotor hub H for example, without the need for a separate composite or metallic cuff and other associated attachment hardware. The main core 46 may be formed from a plurality of separate core pieces, each of which may be fabricated from a distinct core material to provide particular lift and strength properties.

The leading edge assembly 52 generally includes a main sheath laminate 60 upon which is mounted a wear-resistant material as an abrasion resistant system. As shown in FIG. 3A, the abrasion resistant system can be multiple strips, such as the shown first erosion strip 62 and second erosion strip 64 to provide abrasion protection. Alternatively, as shown in FIG. 3B, the sheath laminate 60 may include a single erosion strip 64 as the abrasion resistant system to provide the abrasion protection. Additional structures, such as weight cups 61, leading edge counter weights 63, and trim tab systems 65 for example, may also be provided, in a manner known to a person having ordinary skill in the art. The tip assembly 42 generally includes a main tip core 66, a tip end pocket core 68, a tip leading edge assembly 70, and a tip cap 28. The main tip core 66 is substantially aligned with a longitudinal axis of the main core 46 and is positioned directly adjacent the third piece 58 of the main core 46.

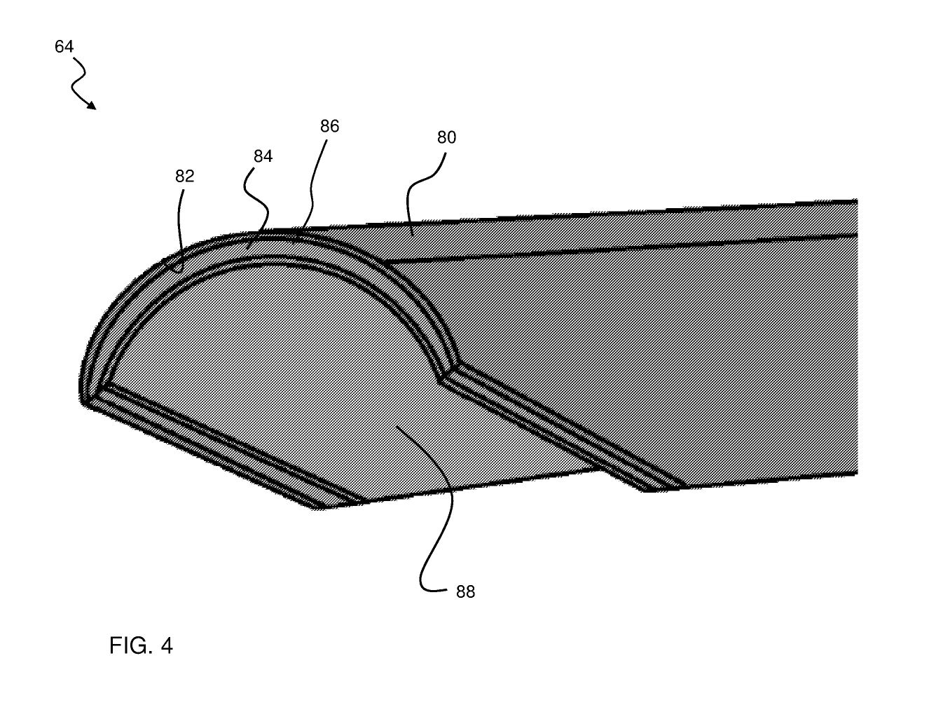

Referring now to FIG. 4, an example of the erosion strip 64 is illustrated in more detail. The erosion strip 64 includes an outer layer 80 having a contour generally complementary to the outer mold line of the blade. The outer layer 80 may be formed from an abrasion and wear resistant material, including, but not limited to nickel, ceramic, titanium, or stainless steel for example. In one embodiment, the thickness of the outer layer 80 is between about 0.005 and 0.035 inches. While not required in all aspects, the outer layer 80 can be manufactured from AM355. It should be understood that a variety of wear-resistant materials may alternatively or additionally be provided for the leading edge assembly 52.

Extending over at least a portion of an interior surface 82 of the outer layer 80 is an elastomer 84, such as rubber for example. The selected elastomer 84 is sufficient to endure the vibratory strain thereon. By way of example, the elastomer 84 may be of a thickness at or between about 0.020 and 0.080 inches. However, other thicknesses are within the scope of the invention. A ratio of the thickness of the elastomer 84 to the outer layer 80 may be between about 1:1.75 to about 16:1. In addition, inclusion of the elastomer 84 is compatible with a portion of an adjacent ice removal system (not shown), such as a heater thereof for example. In one embodiment, the elastomer 84 extends over the entire interior surface 82 of the outer layer 80. A first surface 86 of the elastomer 84 may be bonded to the adjacent interior surface 82 of the outer layer 80 with an epoxy or other adhesive for example. In another embodiment, the elastomer 84 is vulcanized to the interior surface 82 of the outer layer 80. An adhesive 88 adheres the elastomer 84 to the leading edge of the blade, such as at the main sheath laminate 60 of FIG. 3A or the leading edge main sheath laminate 60 of FIG. 3B. In this way, the elastomer 84 reduces the effect of a strain mismatch between the leading edge of the blade and the outer layer 80 which, without the elastomer 84, could lead to a disbonding at the adhesive layer 88.

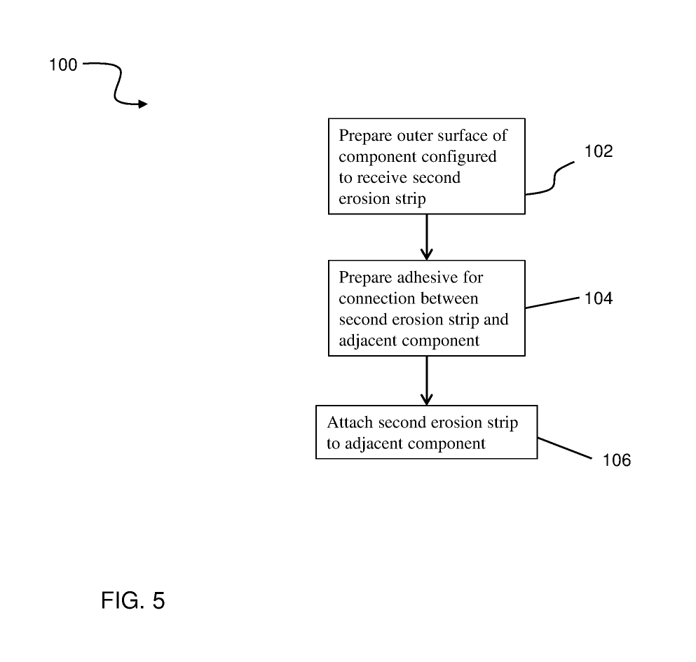

A method 100 for installing the erosion strip 64 of the main blade assembly 40 is illustrated in FIG. 5. As shown in block 102, an outer surface of a component configured to receive the erosion strip 64, such as the first erosion strip 62 or the main sheath laminate 60 for example, is generally prepared such as by cleaning the surface 69 (FIG. 3A) for example. In embodiments where the erosion strip 64 is being replaced, preparation of the outer surface 69 includes removing any material from a previous erosion strip or any material used to attach the erosion strip thereto. In block 104, an adhesive 88 configured to chemically couple the erosion strip 64 to the outer surface of the component is then prepared. In one embodiment, the adhesive 88 is a paste or film that is applied either to the exterior surface of either the first erosion strip 62 or the main sheath laminate 60 or to an interior surface of the elastomer 84 of the erosion strip 64. Alternatively, the adhesive 88 may be prepared by removing a protective lining or other material to expose the adhesive material. Once the adhesive 88 is prepared, the erosion strip 64 is aligned with and connected to either the main sheath laminate 60 or the first erosion strip 62, as shown in block 106, by arranging the adhesive 88 in contact with the prepared outer surface 69.

The layer of elastomer 84 positioned between the outer surface 69 and the outer layer 80 of the erosion strip 64 is able to withstand a high strain generated by the vibratory forces of the main rotor blade 20. As a result, inclusion of the elastomer 84 prevents cracking or disbonding of the hard outer layer 80 from the composite leading edge material, thereby improving the durability and life of the erosion strip 64.

While the invention has been described in detail in connection with only a limited number of embodiments, it should be readily understood that the invention is not limited to such disclosed embodiments. Rather, the invention can be modified to incorporate any number of variations, alterations, substitutions or equivalent arrangements not heretofore described, but which are commensurate with the spirit and scope of the invention. By way of example, while shown with an integrated cuff as the root section 22, it is understood that aspects of the invention can be used with other types of root sections, such as root end cuff that is attached to the main rotor spar through a multiple fastener configuration, each fastener of which must be torqued to a required standard. Further, while shown in the context of a rotary wing aircraft, it is understood that aspects could be used with blades used on fixed wing aircraft, wind turbines, maritime propellers or other blades where edges need abrasive protection. Additionally, while various embodiments of the invention have been described, it is to be understood that aspects of the invention may include only some of the described embodiments. Accordingly, the invention is not to be seen as limited by the foregoing description, but is only limited by the scope of the appended claims.

1. An erosion strip to protect a leading edge surface, comprising:
an outer layer comprising a wear-resistant material;
an elastomer affixed to an interior surface of the outer layer; and
an adhesive layer shaped to adhere the leading edge surface to the elastomer such that the elastomer and adhesive layers are between the outer layer and the leading edge surface; wherein the elastomer is configured to at least partially isolate strain at the outer layer from strain between the adhesive layer and the leading edge surface.

2. The erosion strip according to claim 1, wherein the outer layer is formed from a nickel material.

3. The erosion strip according to claim 1, wherein the elastomer is bonded to the interior surface of the outer layer with an epoxy.

4. The erosion strip according claim 1, wherein the elastomer is vulcanized to the interior surface of the outer layer.

5. The erosion strip according to claim 1, wherein the elastomer extends over all of the interior surface of the outer layer.

6. The erosion strip according to claim 1, wherein the outer layer is formed from a ceramic material.

7. A main rotor blade assembly comprising:
a spar;
a leading edge assembly including:
a main sheath laminate; and
a first erosion strip including a wear-resistant outer layer, a layer of elastomer attached to and extending over at least a portion of an interior surface of the outer layer, and an adhesive which adheres the elastomer to the main sheath laminate, the elastomer being configured to at least partially isolate the strain at the outer layer from strain generated between the adhesive and the main sheath laminate.

8. The main rotor blade assembly according to claim 7, wherein the elastomer is vulcanized to the interior surface of the outer layer.

9. The main rotor blade assembly according to claim 7, wherein the elastomer is bonded to the interior surface of the outer layer with an epoxy.

10. The main rotor blade assembly according to claim 7, wherein an adhesive is arranged over an exposed surface of the elastomer, the adhesive being configured to couple the erosion strip to an adjacent component of the leading edge assembly.

11. The main rotor blade assembly according to claim 10, wherein the adhesive bonds the first erosion strip directly to a portion of the main sheath laminate.

12. The main rotor blade assembly according to claim 10, further comprising a second erosion strip mounted upon the main sheath laminate, the second erosion strip being formed from a wear-resistant material, wherein the adhesive is configured to bond the first erosion strip to the second erosion strip.

13. A method of installing an erosion strip of a main rotor blade comprising:
preparing a surface of an adjacent component configured to receive the erosion strip, the erosion strip including an outer layer of a wear-resistant material and an elastomer affixed to a portion of outer layer, the elastomer being configured to at least partially isolate the outer layer from strain generated in the erosion strip;
preparing an adhesive configured to couple to the erosion strip to the adjacent component; and
affixing the erosion strip to the adjacent component.

14. The method according to claim 13, wherein the adjacent component is another erosion strip of a leading edge assembly of the main rotor blade.

15. The method according to claim 13, wherein the adjacent component is a main sheath laminate of a leading edge assembly of the main rotor blade.
